(19) United States
(12) Patent Application Publication
(10) Pub. No.: US 2018/0052035 A1
(43) Pub. Date: Feb. 22, 2018

(54) Vibronic Sensor with a Tuning Element

(71) Applicant: Endress + Hauser GmbH + Co. KG, Maulburg (DE)

(72) Inventors: Raphael Kuhnen, Schliengen (DE); Mohd S. Affendi Ibrahim, Kota Bharu (MY); Dietmar Fruhauf, Lorrach (DE)

(21) Appl. No.: 15/555,569

(22) PCT Filed: Feb. 15, 2016
(86) PCT No.: PCT/EP2016/053090

§ 371 Date: Sep. 5, 2017

(30) Foreign Application Priority Data
Mar. 3, 2015 (DE) 10 2015 103 071.3

(51) Int. Cl. G01F 23/296

(52) U.S. Cl. CPC G01F 23/2967; G01N 11/16

(57) ABSTRACT

A vibronic sensor for monitoring a process variable of a medium in a containment, comprising a mechanically oscillatable unit, a driving/receiving unit and an electronics unit. The mechanically oscillatable unit has two oscillatory rods and a tuning element of variable stiffness mechanically connected with at least one of the oscillatory rods. At least a first, outer, oscillatory rod is tubular and surrounds a second, inner, oscillatory rod coaxially, wherein each of the two oscillatory rods is secured in such a manner on a shared carrier that each oscillatory rod can execute oscillations transversely to its longitudinal direction. The driving/receiving unit is embodied, based on an electrical excitation signal, to excite the two oscillatory rods in an opposite sense, transverse, mechanical, resonant oscillations, and to receive oscillations of the mechanically oscillatable unit and to convert them into an electrical, received signal, wherein the electronics unit is embodied to tune the stiffness of the tuning element and to ascertain at least from the electrical, received signal, the at least one process variable, and wherein the tuning element includes at least one component of a material, which has a giant delta E effect.

The invention relates to a vibronic sensor for determining and/or monitoring at least one process variable of a medium in a containment, comprising an oscillatable unit, a driving/receiving unit and an electronics unit. The containment is, for example, a container, a tank, or even a pipeline. The process variable can be, for example, a predetermined fill level of the medium in the containment, or the density or the viscosity of the medium.

Such field devices, also referred to as vibronic sensors, have, especially in the case of fill-level measuring devices, for example, an oscillatory fork, single rod or membrane as oscillatable unit. The oscillatable unit is excited during operation to execute mechanical oscillations by means of a driving/receiving unit, usually in the form of an electromechanical transducer unit, which can, in turn, be, for example, a piezoelectric drive or an electromagnetic drive.

Corresponding field devices are produced by the applicant in great variety and sold, for example, under the marks, LIQUIPHANT and SOLIPHANT. The underpinning measuring principles are basically known. The driving/receiving unit excites the mechanically oscillatable unit by means of an electrical excitation signal to execute mechanical oscillations. In the other direction, the driving/receiving unit receives mechanical oscillations of the mechanically oscillatable unit and transduces such into an electrical, received signal. The driving/receiving unit can be a separate drive unit and a separate receiving unit, or a combined driving/receiving unit.

Both the excitation signal as well as also the received signal are characterized by their frequency, amplitude and/or phase. Changes in these variables are then usually taken into consideration for determining the respective process variable. In the case of a vibronic limit level switch for liquids, it is, for example, distinguished whether the oscillatable unit is oscillating covered by the liquid or freely oscillating. These two states, the free state and the covered state, are then distinguished, for example, in the case of a LIQUIPHANT instrument, used, as a rule, for liquid media, based on different resonance frequencies, thus a frequency shift, and in the case of the SOLIPHANT instrument, used mainly for bulk goods, based on a change of the oscillation amplitude.

An advantage of applying an oscillatory fork as mechanically oscillatable unit is that the two fork tines execute oscillations of opposite phase in such a manner that no energy or force is transmitted from the fork tines to a clamping region, by means of which the oscillatory fork is connected with a membrane. In contrast, it is for applications, in the case of which, for example, medium can get stuck between the fork tines, then advantageous to use a so-called single rod oscillator. This is, however, in given cases, disadvantageous with reference to signal stability as well as with reference to the compensation of forces on the clamping region, as compared with an oscillatory fork.

Various embodiments of a vibronic sensor with a single rod as oscillatable unit are known, for example, from the documents DE3011603A1 and DE3625779C2. The oscillatable unit includes two oscillatory rods, of which at least one is tubular and coaxially surrounds the other oscillatory rod, thus an inner, oscillatory rod and an outer, hollow, oscillatory rod. Moreover, each of the two oscillatory rods is so secured on a shared carrier via an elastic holding part acting as return spring that it can execute oscillations transversely to its longitudinal direction. Each oscillatory rod forms thus with the elastic holding part a mechanical, oscillatory system, whose eigenresonance frequency is determined by the mass moment of inertia of the oscillatory rod as well as the spring constant of the elastic holder. In order that no reaction forces act on the clamping apparatus, whereby, among other things, oscillatory energy could be lost, the two oscillatory rods, i.e. the two oscillatory systems, are usually embodied in such a manner that they, in the case of no contact with a medium, have the same eigenresonance frequency and execute oppositely sensed oscillations. In the case of a given excitation power, then the oscillation amplitude is maximum. In the case of covering with medium, in contrast, the oscillation amplitude is damped, or zero. In this case, the amplitude damping is a measure for the fill level.

Now, it is, however, the case that, due to accretion formation or corrosion on the outer, oscillatory rod in the face of continued contact with medium, the eigenresonance frequency of the outer, oscillatory rod, i.e. of the outer, oscillatory system, changes. Thus, accretion increases, for example, the mass of the outer, oscillatory system and, associated therewith, its mass moment of inertia. Then, the eigenresonance frequencies of the outer and inner, oscillatory systems are no longer identical with one another, which leads to a lessening of the maximum oscillation amplitude. Correspondingly, it can happen that the electronics unit can no longer distinguish whether a measured lessening of the oscillation amplitude was brought about by accretion formation or by reaching a certain fill level.

In order to combat this problem, it is known, for example, from DE19651362C1, to arrange on at least one of the oscillatory rods a compensation mass, which is displaceable in the longitudinal direction of the oscillatory rod, and, for the automatic adjustment of the eigenresonance frequencies of the two oscillatory rods, i.e. the oscillatory systems, to integrate a tuning apparatus for adjusting the compensation mass. Depending on the concrete embodiment of the tuning apparatus, there are, however, limits to this solution.

The eigenresonance frequency of an oscillatory rod is, however, also dependent on the stiffnesses of the material used for its manufacture. As described in WO2005/0885770A2, this relationship can be used for a targeted varying of the eigenresonance frequency of an oscillatory rod.

For the example of a vibronic sensor with a single rod as oscillatable unit, for example, a variable stiff tuning unit can be coupled with at least one of the oscillatory rods. The tuning unit is composed then, in turn, for example, at least partially, of a piezoelectric or magnetostrictive material, whose stiffness can be electrically controlled by means of a control unit. In the case of piezoelectric material and corresponding electrodes as tuning unit, the stiffness is changed by an electrical current flowing between the electrodes. Either then the electrodes are free, so that no electrical current can flow, or they are short-circuited, wherein the stiffness in the short-circuited state is the smallest. If, in contrast, a magnetostrictive material is used, the stiffness of this material can, in contrast, be adjusted by an applied magnetic field of variable strength passing through the material. However, comparatively large fields are necessary, which, for application in field devices, can be disadvantageous in cases where an as low as possible power consumption is desired.

Therefore, an object of the present invention is to provide an electrical current saving vibronic sensor with a single rod as oscillatable unit, in the case of which the eigenresonance frequencies of the inner and outer, oscillatory systems can be tuned relative to one another steplessly and simply.

This object is achieved according to the invention by a vibronic sensor for monitoring at least one process variable of a medium in a containment, comprising a mechanically oscillatable unit, a driving/receiving unit and an electronics unit, wherein the mechanically oscillatable unit has two oscillatory rods and a tuning element of variable stiffness mechanically connected with at least one of the oscillatory rods, wherein at least a first oscillatory rod is tubular and coaxially surrounds a second, inner, oscillatory rod, wherein each of the two oscillatory rods is secured in such a manner on a shared carrier that each oscillatory rod can execute oscillations transversely to its longitudinal direction, wherein the driving/receiving unit is embodied, based on an electrical excitation signal, to excite the two oscillatory rods to opposite sense, transverse, mechanical, resonant oscillations, and to receive oscillations of the mechanically oscillatable unit and to convert them into an electrical, received signal, wherein the electronics unit is embodied to tune the stiffness of the tuning element and to ascertain, at least from the electrical, received signal, the at least one process variable, and wherein the tuning element includes at least one component of a material, which has a giant delta E effect.

A basic idea of the invention is thus to provide a targeted influencing of an eigenresonance frequency of at least one of the two oscillatory rods by varying its stiffness. The so-called giant delta E materials used for this, according to the invention, have a giant delta E effect and are distinguished by a high saturation magnetostriction coupled with a simultaneously comparably less magnetic anisotropy energy. In this way, there results in comparison to conventional magnetostrictive materials an especially high variation of the modulus of elasticity in the case of a comparatively small variation of the magnetization. The modulus of elasticity and therewith the stiffness can thus be varied by comparatively small variation of a magnetic field. Because, for this, only comparatively weak fields are required, a corresponding field device is distinguished by a low power consumption. This is especially advantageous for field devices with a 4-20 mA- or NAMUR interface.

In a preferred embodiment, the material, which has a giant delta E effect, is an amorphous ferromagnetic material, especially an amorphous metal, or a metal glass. From the absence of long-range order in these materials, there results the absence of a magnetocrystalline anisotropy, which leads to the occurrence of the so-called giant delta E effect. As described, for example, in ““Giant” ΔE-Effect and Magnetomechanical Damping in Amorphous Ferromagnetic Ribbons” by N. P Kobelev et al., Phys. Stat. Sol. (a) 102, 773 (1987), the order of magnitude of the elasticity change ΔE of a material depends quite generally on the size of the induced magnetic anisotropy K, as well as on the mechanical stress a and is especially large in case K≈λ_{S}σ, wherein λ_{S} is the coefficient of magnetostriction.

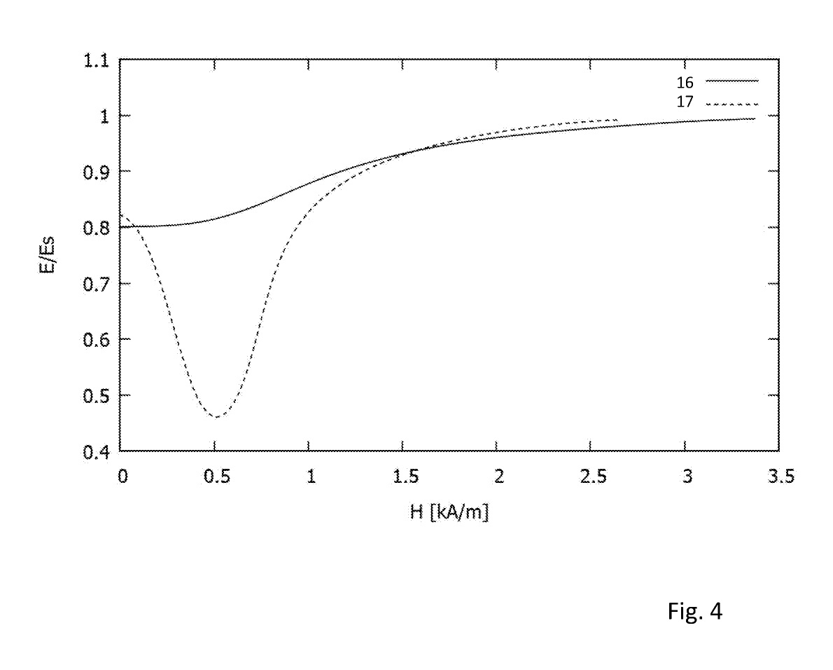

In an additional preferred embodiment, the material, which has a giant delta E effect, is a rapidly cooled metal melt of a magnetostrictive material. In such case, it is advantageous, when the rapidly cooled metal melt is treated thermally, or thermomagnetically. Rapid cooling of metal melts is frequently applied for manufacture of metal glasses. Cooling rates of up to 10⁶ K/s can prevent the crystallization typical for metals. Thermal or thermomagnetic treatment reduces mechanical warping and/or the occurrence of a preferential direction for the magnetization. The effects of such treatments on the size of the giant delta E effect are described in greater detail in connection with FIG. 4.

Advantageously, the rapidly cooled metal melt is in strip, band or tape form, wherein the at least one component variable in stiffness is composed of at least two layers of the strip, band or tape material arranged on top of one another. In such case, it is especially advantageous, when the strip, band or tape material is laminated. The at least one component variable in stiffness can be produced, for example, by multiple winding of at least one other component of the vibronic sensor.

In a preferred embodiment, the tuning element includes means for producing a magnetic field. In such case, the means for producing the magnetic field is advantageously arranged in such a manner that the magnetic field extends parallel to the plane of the strip, band or tape material in its longitudinal direction. In this way, the magnetic field is oriented in such a manner that it extends along a preferential direction for magnetizing the material. The elasticity change due to a variation of the applied magnetic field is maximum in this case.

In a preferred embodiment, the means for producing a magnetic field has at least one coil. By means of a coil, the magnetic field can be varied in simple manner by changing an electrical current flowing through the coil.

In an especially preferred embodiment, the tuning element is secured at least partially to the inner, oscillatory rod in such a manner that a change of the stiffness of the tuning element results in a change of a resonant frequency of the inner, oscillatory rod. In the case, in which, due to accretion formation or corrosion, the eigenresonance frequency of the outer, oscillatory rod changes, the eigenresonance frequency of the inner, oscillatory rod can be changed by varying the stiffness in such a manner that the eigenresonance frequencies of the two oscillatory rods in the absence of contact with medium have again the same value.

In a preferred embodiment, the at least one coil is arranged in the interior of the inner, oscillatory rod. Notwithstanding that the at least one coil can also be arranged outside of the inner, oscillatory rod, the arrangement within the inner, oscillatory rod is especially advantageous for saving space.

Advantageously, the oscillatory rods are embodied in such a manner that the resonance frequencies of the inner and outer, oscillatory rods have essentially the same value when the oscillatable unit is not in contact with the medium. Thus, the oscillatory rods oscillate in the absence of contact with medium, in the case of given excitation power, in each case, with the maximum oscillation amplitude.

An especially preferred embodiment of the present invention includes that the electronics unit is embodied to tune the electrical current through the coil based on the oscillation amplitude of the oscillatable unit in such a manner that the resonant frequency of the inner, oscillatory rod equals the resonant frequency of the outer, oscillatory rod. Thus, a tuning of the eigenresonance frequencies of the two oscillatory rods can be performed either at selected points in time or continuously. If, for example, in spite of the tuning, an oscillation amplitude can no longer be detected, it can be deduced therefrom that the oscillatable unit is covered with medium.

In such case, it is advantageous to furnish within the electronics unit a characteristic curve, which gives the stiffness of the tuning element as a function of an eigenresonance frequency of the oscillatable unit, and to tune the frequency of the excitation signal and, based on the frequency of the excitation signal, the stiffness in such a manner that the oscillatable unit executes resonant oscillations. This embodiment utilizes the relationship between the stiffness of the oscillatory rod and its frequency spectrum. Associated with each value for an eigenresonance frequency is a stiffness value and therewith a certain electrical current flowing through the coil. In this way, a vibronic sensor with a single rod as oscillatable unit can be applied with clearly increased signal stability for liquids. The evaluation of the received signal and the excitation of resonant oscillations occurs analogously to the arrangements and methods known from the state of the art for an oscillatory fork as oscillatable unit, such as described, by way of example, in the documents, DE102006034105A1, DE102007013557A1, DE102005015547A1, DE102009026685A1, DE102009028022A1, DE102010030982A1 or DE00102010030982A1.

It is, in given cases, advantageous that the oscillatable unit be arranged in a defined position within the container, in such a manner that it extends to a determinable immersion depth in the medium. This arrangement permits determining density and/or viscosity, analogously to the procedures explained in the documents, DE10050299A1, DE102006033819A1, DE102007043811A1, DE10057974A1 or DE102006033819A1.

Advantageously, the driving/receiving unit is at least one piezoelectric element, or an electromagnetic driving/receiving unit.

The invention as well as advantageous embodiments thereof will now be described in greater detail based on the appended drawing, the figures of which show as follows:

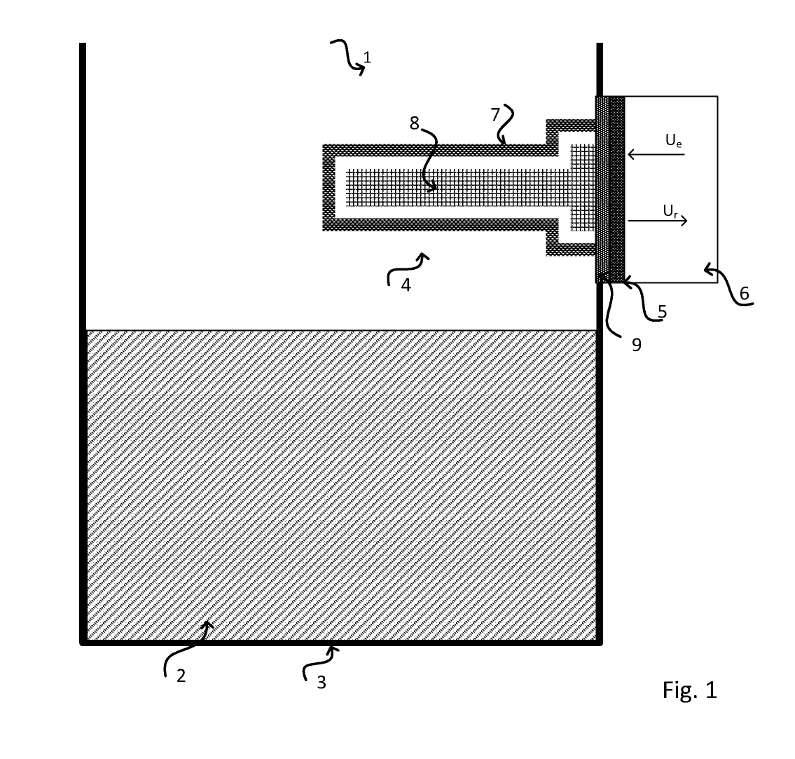

FIG. 1 a schematic sketch of a vibronic sensor according to state of the art,

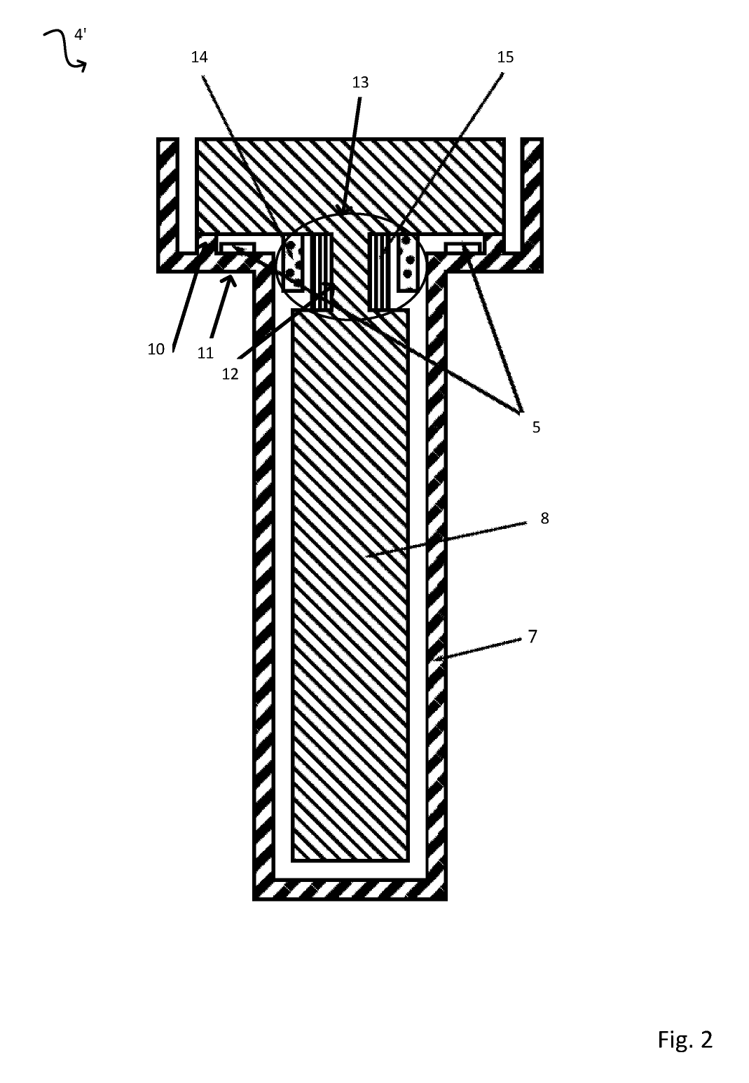

FIG. 2 a schematic sketch of a vibronic sensor of the invention,

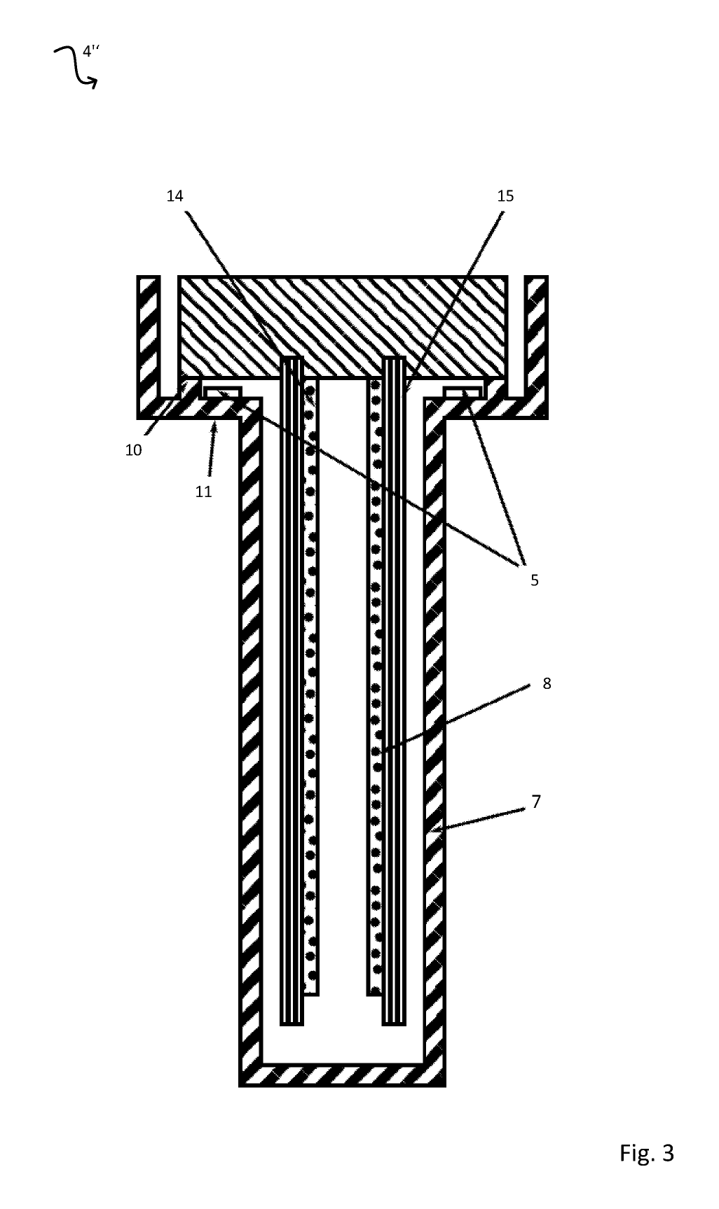

FIG. 3 a schematic sketch of an alternative embodiment of a vibronic sensor of the invention, and

FIG. 4 a schematic graph of change of modulus of elasticity as a function of magnetic field for differently treated giant delta E materials.

FIG. 1 shows a vibronic sensor 1 with a single rod as mechanically oscillatable unit 4 arranged at a defined height on a container 3 filled partially with medium 2. The oscillatable unit 4 is excited by means of the driving/receiving unit 5 to execute mechanical oscillations. Driving/receiving unit 5 can be, for example, a piezoelectric stack- or bimorph drive or an electromagnetic drive. The mechanically oscillatable unit 4 includes an inner, oscillatory rod 8 and an outer, oscillatory rod 7, wherein the outer, oscillatory rod 7 coaxially surrounds the inner, oscillatory rod 8, and comes in contact with the medium 2, as soon as a certain fill level is achieved. The outer, oscillatory rod 7 and the inner, oscillatory rod 8 are mechanically connected with one another via a carrier 9, for example, a membrane.

Furthermore, an electronics unit 6 is shown, by means of which signal registration,—evaluation and/or—feeding occurs. The excitation of the oscillatable unit 4 occurs by means of an electrical excitation signal Uₑ, and the particular process variable is ascertained from an electrical, received signal Uᵣ, which represents the mechanical oscillations of the mechanically oscillatable unit 4.

FIG. 2 shows a first embodiment of an oscillatable unit 4′ of the invention. The outer, oscillatory rod 7 is connected via a rib 10 on a membrane 11 with the inner, oscillatory rod 8. The eigenresonance frequency of the outer, oscillatory rod 7 is determined by the mass moment of inertia of the outer, oscillatory rod 7 in the form of a tube and the spring action of the membrane 11; while the eigenresonance frequency of the inner, oscillatory rod 8 is determined, in contrast, by the mass moment of inertia of the inner, oscillatory rod 8 and the spring action of the oscillatory rod 8 as well as the spring action in the region of its neck 12 on the connection side with the membrane 11. In such case, the eigenresonance frequencies of the two oscillatory rods 7, 8 are tuned in such a manner that, in the absence of contact of the outer, oscillatory rod 7 with the medium 2, they have the same value. If the outer, oscillatory rod 7 is caused by means of the driving/receiving unit 4 (not shown) to execute mechanical, resonant oscillations, the inner, oscillatory rod 8 is caused via the mechanical connection with the membrane 11 to execute opposite phase, mechanical oscillations.

Furthermore, the oscillatable unit 4′ of the invention according to FIG. 2 includes a variably stiff, tuning element 13, which includes a component 15 of a material, which has a giant delta E effect, as well as means for producing a magnetic field, in the form of a coil 14, which is arranged outside of the inner, oscillatory rod 8. Component 15 of the material, which has a giant delta E effect, is preferably a laminated strip, band or tape material of a rapidly cooled metal melt. This can be wound, for example, around the region of the neck 12 of the inner, oscillatory rod 8, until a desired thickness is achieved. It is understood, however, that also other arrangements and materials are possible for the component 15 of a material, which has a giant delta E effect.

By means of the electronics unit 6 (not shown), the electrical current through the coil 14, and, associated therewith, the stiffness, or the eigenresonance frequency, of the inner, oscillatory rod 8 can be tuned in such a manner that the eigenresonance frequency of the inner, oscillatory rod 8 equals the eigenresonance frequency of the outer, oscillatory rod 7.

The alternative embodiment of an oscillatable unit 4″ of the invention according to FIG. 3 differs from that of FIG. 2 only by the feature that the coil 14′ is arranged not outside of the inner, oscillatory rod 8, but, instead, within the inner, oscillatory rod 8. This solution is thus especially space saving.

It is understood, however, that also other embodiments for an oscillatable unit 4 are possible, which likewise fall within the scope of the present invention.

Advantageously, a vibronic sensor of the invention 1 with an oscillatable unit 4 in the form of a single rod can also be used in liquids. In the case of liquids, usually the frequency of the received signal Uᵣ is evaluated, such being influenced both by accretion formation, corrosion as well as also by contact with the particular liquid. Through a continuous adapting of the stiffness of the inner, oscillatory rod 8, for example, based on a control loop and based on furnished characteristic curves, then the vibronic sensor of the invention 1 can also be used in liquids.

FIG. 4 shows, finally, schematically, a graph of change of modulus of elasticity as a function of the magnetic field for differently treated, giant delta E materials. The presentation is done analogously to that in the article ““Giant” ΔE-Effect and Magnetomechanical Damping in Amorphous Ferromagnetic Ribbons” by N. P. Kobelev et al., published in Phys. Stat. Sol. (a) 102, 773 (1987). The solid curve in FIG. 4 shows the change of modulus of elasticity of a rapidly cooled metal melt 16 exhibiting the giant delta E effect. The same material shows, after a magnetic field solution annealing perpendicular to the direction of the subsequently applied magnetic field, thus a thermomagnetic treatment 17, the behavior shown by means of the dashed curve. The thermomagnetic treatment leads to a clearly greater change of the modulus of elasticity in the case of small field strengths and is, thus, especially advantageous for use in a vibronic sensor of the invention.

As mentioned above, so-called giant delta E materials are distinguished by a high saturation magnetostriction coupled with simultaneously comparably less magnetic anisotropy energy. Especially suitable here are amorphous materials, especially rapidly cooled metal melts, such as offered, for example, by the firm, Metglas Inc. (www.Metglas.com), especially the material, Metglas 2605. See also the article “ΔE effect in obliquely field annealed metglas26055C” by P. T. Squire and M. R. J. Gibbs, published in IEEE Transactions on Magnetics, Vol. 25, No. 5, September 1989. In the case of untreated material, the magnetic field induced stiffness change is about 20%, while this, depending on treatment, especially a thermal or thermomagnetic treatment, can grow to 55%. Other suitable materials include, for example, various VITROVAC-alloys of the firm, Vacuumschmelze, which have, in the untreated case, stiffness changes up to 30%. These materials are usually delivered as strip, band or tape material, and can be used in the form of laminates.

In comparison with this, according to the article, “Giant magnetically induced changes in elastic moduli in Tb.3Dy.7Fe2,” IEEE Transactions on Sonics and Ultrasonics, Vol. 22(1), Pgs. 50-52, of January 1975, a typical and frequently applied representative of the class, magnetostrictive materials, Terfenol-D, with a magnetostriction of, depending on prestress, λ≈1000-2000 ppm, has a ΔE effect of E/E_{S}≈40% in the case of a magnetic field strength of about 340 kA/m. In the case of a giant delta E material, such as e.g. a Vitrovac alloy, in comparison, field strengths smaller by a factor of 100 are necessary for stiffness changes of equal orders of magnitude. In the case of choice of a treated giant delta E material, such as, for example, Metglas 2605, a magnetic field strength of only, for example, about 500 A/m is necessary for achieving a stiffness change comparable to the material Terfenol-D. This corresponds, in the case of application of a coil of 1 cm length and, for instance, 500 windings, according to H=nl/L, to an electrical current from I=10 mA. Depending on embodiment of the tuning element, thus, the solution of the invention permits operating the corresponding vibronic sensor with a 4-20 mA- or NAMUR-interface. This is not possible in the case of conventional magnetostrictive materials.

### LIST OF REFERENCE CHARACTERS

1 vibronic sensor

2 medium

3 container

4 oscillatable unit

5 driving/receiving unit

6 electronics unit

7 outer, oscillatory rod

8 inner, oscillatory rod

9 carrier

10 rib

11 membrane

12 neck

13 tuning element

14 coil

15 component of giant delta E material

16 untreated, giant delta E material

17 thermomagnetically treated, giant delta E material

Uₑ excitation signal

Uᵣ received signal

1-16. (canceled)

17. A vibronic sensor for monitoring a process variable of a medium in a containment, comprising:
a mechanically oscillatable unit;
a driving/receiving unit; and
an electronics unit, wherein:
said mechanically oscillatable unit has two oscillatory rods and a tuning element of variable stiffness mechanically connected with at least one of said oscillatory rods;
at least a first, outer, oscillatory rod of said two oscillatory rods is tubular and coaxially surrounds a second, inner, oscillatory rod;
each of said two oscillatory rods is secured in such a manner on a shared carrier that each oscillatory rod can execute oscillations transversely to its longitudinal direction;
said driving/receiving unit is embodied, based on an electrical excitation signal, to excite said two oscillatory rods in an opposite sense, transverse, mechanical, resonant oscillations, and to receive oscillations of said mechanically oscillatable unit and to convert them into an electrical, received signal;
said electronics unit is embodied to tune the stiffness of said tuning element and to ascertain, at least from the electrical, received signal, the at least one process variable; and
said tuning element includes at least one component of a material, which has a giant delta E effect.

18. The vibronic sensor as claimed in claim 17, wherein:
the material, which has a giant delta E effect, is an amorphous, ferromagnetic material, especially an amorphous metal, or a metal glass.

19. The vibronic sensor as claimed in claim 17, wherein:
the material, which has a giant delta E effect, is a rapidly cooled metal melt of a magnetostrictive material.

20. The vibronic sensor as claimed in claim 19, wherein:
the rapidly cooled metal melt is treated thermally, or thermomagnetic.

21. The vibronic sensor as claimed in claim 19, wherein:
the rapidly cooled metal melt is a strip, band or tape material, and an at least one component variable in stiffness is composed of at least two layers of the strip, band or tape material arranged on top of one another.

22. The vibronic sensor as claimed in claim 21, wherein:
said strip, band or tape material is laminated.

23. The vibronic sensor as claimed in claim 17, wherein:
said tuning element includes means for producing a magnetic field.

24. The vibronic sensor as claimed in claim 23, wherein:
the means for producing the magnetic field is arranged in such a manner that the magnetic field extends parallel to the plane of said strip, band or tape material in its longitudinal direction.

25. The vibronic sensor as claimed in claim 23, wherein:
said means for producing a magnetic field has at least one coil.

26. The vibronic sensor as claimed in claim 17, wherein:
said tuning element is secured at least partially to said inner, oscillatory rod in such a manner that a change of the stiffness of said tuning element results in a change of an eigenresonance frequency of said inner, oscillatory rod.

27. The vibronic sensor as claimed in claim 17, wherein:
said at least one coil is arranged in the interior of said inner, oscillatory rod.

28. The vibronic sensor as claimed in claim 17, wherein:
said oscillatory rods are embodied in such a manner that the eigenresonance frequencies of the inner and outer oscillatory rods have essentially the same value when said oscillatable unit is not in contact with the medium.

29. The vibronic sensor as claimed in claim 17, wherein:
said electronics unit is embodied to tune the electrical current through said coil based on the oscillation amplitude of said oscillatable unit in such a manner that the eigenresonance frequency of said inner, oscillatory rod equals the eigenresonance frequency of said outer, oscillatory rod.

30. The vibronic sensor as claimed in claim 17, wherein:
there is furnished within the electronics unit a characteristic curve, which gives the stiffness of said tuning element as a function of an eigenresonance frequency of said oscillatable unit and the frequency of the excitation signal and, based on the frequency of the excitation signal, the stiffness of said tuning element are tuned in such a manner that said oscillatable unit executes resonant oscillations.

31. The vibronic sensor as claimed in claim 17, wherein:
said oscillatable unit is arranged in a defined position within the containment, in such a manner that it extends to a determinable immersion depth in the medium.

32. The vibronic sensor as claimed in claim 17, wherein:
said driving/receiving unit is at least one piezoelectric element, or said driving/receiving unit is an electromagnetic driving/receiving unit.
